(19) United States
(12) Patent Application Publication
(10) Pub. No.: US 2003/0079368 A1
(43) Pub. Date: May 1, 2003

(54) Flat material dryer

(76) Inventor: Karl H. Hoffman, Tequesta, FL (US)

Correspondence Address: MCHALE & SLAVIN, 4440 PGA BLVD, SUITE 402, PALM BEACH GARDENS, FL, 33410

(21) Appl. No.: 10/035,808

(22) Filed: Oct. 25, 2001

(51) Int. Cl. F26B 19/00; F26B 25/06

(52) U.S. Cl. 34/202; 34/201

(57) ABSTRACT

A material drying apparatus having a sealable chamber for receipt of wet material, such as clothing. Material placed into the chamber is dried upon the evacuation of air from the chamber wherein moisture drawn from the material is condensed on a condensate coil placed in the chamber. Heating coils placed around the chamber or beneath a drawer elevate the temperature to enhance condensate operation providing an energy efficient material dryer requiring no make-up air. Drum or thermal blanket enhances temperature elevation. Condensed water is purged after the drying process although provisions provide for an interim purge should excess liquid be drawn from the material.

### FIELD OF THE INVENTION

This invention relates to material dryers, and in particular to a dryer configured for minimal space consumption by use of a flat, upright positioned drying area employing a vacuum sealed chamber for use in combination with a condenser for drawing moisture at moderate temperatures.

### BACKGROUND OF THE INVENTION

Conventional clothes dryers are relatively large appliances, and consume a great amount of energy. The conventional clothes dryer employs a rotating chamber which receives damp clothing directly after the wash cycle. Air is drawn into the rotating chamber at atmospheric pressure past a heating element. The heated air is used for drawing moisture from the clothes and the moisture laden air is continually exhausted from the clothes dryer.

A conventional clothes dryer needs to be permanently installed at a location proximate an outside vent and an adequate power source. The conventional material dryer expends a large amount of energy as the air drawn into the dryer must be heated. A typical residential electric dryer consumes approximately 2,000 Watts/hour. The high operating temperature can create a fire hazard, particularly with regard to lint.

There are situations where a materials or clothing dryer may be needed where there is limited space, or no adequate AC power source is available. One such instance where a clothes dryer would be desirable would be for marine applications, such as on ocean-going vessels, where size, weight and power consumption considerations would make use of a conventional dryer impossible.

For example, sailboats are capable of traveling to remote locations mainly due to their non-reliance on power consuming items that require fossil fuel for operation. So as not to eliminate all modern conveniences, various appliances are used that operate on minimum power consumption capable of being replaced by solar panels, wind generators, or small fuel operated generators. Such boats are limited for space so that clothing must be washed frequently, making the need for quick clothes drying an important issue. Further, swimming and the use of towels must be dried before storage or mildew can quickly occur. Low power consumption and clothes drying were not compatible, thus only larger motor yachts maintained the luxury of a clothes dryer on a boat.

Alternative arrangements for drying clothing include utilizing a vacuum pump to hasten the removal of the moisture. It is generally known that the evaporation temperature of a liquid decreases as the pressure of the surrounding air decreases. Thus, water can be drawn from a material at lower temperatures in a near vacuum environment thereby expending less energy if a lower temperature can be utilized.

The low drying temperature and shorter drying time provided by a vacuum assisted dryer is highly advantageous in many situations. For example, the drying temperature of a conventional material dryer (approximately 240°) can melt some synthetic materials. Also, material saturated with volatile or flammable liquids could not be dried in a conventional material dryer. Such items could be safely dried in a vacuum assisted dryer.

As a result, a number of prior art devices are directed to the modification of clothes dryers which have been developed to incorporate a vacuum or vacuum like chamber. However, these devices lose efficiency in that they constantly pump air into a chamber for purposes of discharging a volume of air and water vapor out of the device by use of a vacuum pump. Such devices require additional power as the incoming air must be circulated and in most cases heated.

For instance, U.S. Pat. No. 3,425,136 discloses a clothes dryer having an interior drum heater and vertical air ducts wherein the device continuously draws air and water vapor from inside a chamber by use of a vacuum pump. Similarly, U.S. Pat. No. 4,041,614 discloses a device which passes air and water vapor through an exit duct to the exterior of a cabinet. U.S. Pat. No. 4,257,173 discloses a “no heat” clothes dryer which simply incorporates a vacuum source coupled to an exhaust port. U.S. Pat. No. 4,305,211 discloses a clothes drying chamber whereby air and moisture particles from within the chamber are discharged by creation of a suction on the chamber. U.S. Pat. No. 4,615,125 discloses yet another vacuum chamber with a perforated rotatable drum and vacuum pump which draws air and water vapor from the vacuum chamber and contained drum.

U.S. Pat. No. 5,131,169 discloses a clothes dryer with a drum enclosed in a shell having a compressor to remove air and water vapor from the shell. A cyclic operation of pumping heated air into the shell and removing saturated air is employed. U.S. Pat. No. 5,430,956 discloses a clothes drying device employing a turbo engine for drawing air from a drying room and condensing the liquid thereby reducing the volume of air produced by the drying process. U.S. Pat. No. 5,459,945 discloses a vacuum assisted system for drying clothes which includes an evaporation chamber which is located inside a condensation chamber. In this manner the device extracts water from the evaporation chamber by use of a condensation chamber to condense extracted vapor on the outer surface of the evaporation chamber. While the condenser is used, air is continually circulating out of the vacuum chamber by use of the vacuum pump.

The disadvantages of the vacuum pump dryers disclosed in the prior art were overcome in U.S. Pat. Nos. 6,151,795 and 5,806,204, issued to the applicant. These material drying devices disclosed in the '795 and '204 patents are superior to the prior art in that they are constructed to eliminate the constant draw of air into the devices, lower the drying temperature, eliminate a constant evacuation by a vacuum pump, and decreases the amount of time to perform a drying cycle thereby reducing energy and operating costs.

The dryer disclosed in U.S. Pat. No. 5,806,204 is similar to a conventional dryer and includes a drying chamber the size of a conventional dryer basket. The drum is thick walled to withstand vacuum pressures. The outside wall of the drum is heated by the hot side of a refrigerant system. The material to be dried is heated by forcing it against the inside wall of the drum by a rotating belt. A fan blows the evaporated water into the condensing coil of the cold side of the refrigerant system where it is condensed and stored in a container. There are many drawbacks to the approach in the '204 patent. Since there is no air to flow due to the vacuum, convection heating is not possible. Only the portion of the material coming into contact with the drum wall at any given time is heated. In U.S. Pat. No. 6,151,795, the heating problem is addressed by using the difference in atmospheric pressure and the vacuum is used to aid in forcing the material to be dried against the heated surface. The contents of U.S. Pat. No.6,151,795 and U.S. Pat. No.5,806,204 are incorporated herein by reference.

The present invention, as disclosed herein, provides an improvement over these and other prior art material dryers by operating as a press to more efficiently remove moisture from the material, and by delivering more heat to the material while using less power for operation.

### SUMMARY OF THE INVENTION

An objective of the present invention is to provide a material dryer based upon the drawing of a partial vacuum on a sealed chamber with a condensate coil placed within the chamber for use in drawing moisture from clothing placed within the chamber.

Another objective of the present invention is to provide a material dryer that eliminates the need for an in-flow of air.

Still another objective of the present invention is to provide a material dryer with a drying chamber configured as a press to hasten the removal of liquid, and to reduce the amount of air needed to be removed.

Yet another objective of the present invention is to provide a material dryer capable of speeding the drying process by approximately fifty percent while using approximately fifty percent less energy over conventional drying devices.

A further objective is to provide a materials dryer which is significantly smaller in size that a conventional tumbler-type clothing dryer.

Still a further objective is to provide a materials dryer suitable for use on marine craft because of its small size and low power consumption.

Yet another objective of the invention is to teach the use of material dryer that is beneficial for use with car washes where quick drying of cleaning towels is necessary without the expenditure of a large amount of energy.

Another objective of the invention is to teach the use of material dryer that can incorporate a press allowing the embossing of indicia while drying, for instance, allowing a restaurant name to be embossed on a napkin while the napkin is being dried.

Another objective of the invention is to provide a material dryer which can be used where venting is not possible.

Another objective of the invention is to provide a material dryer which can dry fully saturated items without any loss of efficiency.

Another objective of the invention is to provide a material dryer to be used in applications where it is important not to generate lint.

Another objective of the invention is to provide a material dryer which can be used to dry bulky materials, such as open-celled foam rubber and sponges, which cannot be efficiently dried by conventional dryers.

Another objective of the invention is to provide a material dryer which is useful for drying towels in a recreational swimming area.

Another objective of the invention is to provide a material dryer which dries material and presses it at the same time.

Another objective of the invention is to provide a material dryer which can be uses in screen printing applications where speed and low temperatures are important.

The present invention teaches an energy efficient material drying method and device. The material dryer of the present invention employs a sealed chamber that allows a near vacuum to be drawn on material, such as clothing, placed within the chamber. Water in the form of vapor is drawn from the material placed within the device by use of a condenser placed within the chamber. The condenser operates to condense the water vapor evaporated from the material. The material is heated to increase the rate of evaporation and to provide the required heat of vaporization. Because the boiling temperature of water decreases as the pressure in the chamber decreases, evaporation can be maximized while maintaining a safe temperature of the material being dried. The material is placed in contact with the heating elements, such as heated surfaces located above and below the material. Movement of the water vapor from the heated material to the condenser can be enhanced by the use of a fan or similar device if the condenser cannot be located close to the material. The condensed water can be stored within the chamber until the drying cycle is complete or can be purged during the cycle if desired. The operation of the dryer can be controlled by a timer or by sensors which monitor the amount of moisture left in the material, permitting not only full dry operation but also damp dry suitable for operations such as ironing and pressing for material such as clothing.

The chamber is configured as a press, and includes a plurality of elements constructed as a closely aligned “sandwich” assembly which reduces the effect of atmospheric pressure exerted on the chamber when the vacuum is drawn. The chamber is formed from a first shell cover hingedly secured to a second shell cover to form a hermetically sealable interior compartment.

The heat of vaporization needed for evaporation to occur is supplied by heated surfaces placed in thermal contact with the material. The surfaces are heated from the hot side of an air-conditioner compressor either directly by the freon itself or indirectly by water heated by the freon in a heat exchanger. Similarly, the condenser surfaces are cooled from the cold side of the air-conditioner compressor (after the freon has passed through the expansion valve) either directly by the freon itself or indirectly by water cooled by the freon in a heat exchanger. The efficiency of the air-conditioning cycle used to provide simultaneously the heat needed for vaporization and the cold needed for condensation provides a great energy saving over other methods and is an important part of the present invention. For the most part, the energy supplied for heat of vaporization is not lost but rather recovered in the condenser and recycled, reducing the overall energy consumption.

Monitoring of the material dryer is performed by use of conductivity sensors to measure the moisture content of the material being dried. Temperature probes are used to measure various temperatures and pressure sensors to measure pressure inside the chamber. The parameters are preset and allow for operation of the heating/cooling compressor. Activation of the compressor will cause heat to be built up and be distributed through the hot coils surrounding the dryer bin or, alternatively, heating elements not associated with the compressor placed around the drying bin may be activated. In any event the increase of heat speeds up the evaporation of liquid from the material to be dried. The newly released water vapor will thereby condense on the condenser coils and be routed to a liquid collection tank. If the liquid collection tank is filled, the tank may be purged either before, during, or after the drying operation. Sensors can also be used to report the moisture content which is indicative of the amount of drying that has occurred allowing the consumer to remove material, such as clothing to be pressed, before complete drying if preferred.

It is noted that liquid in the collection tank is relatively cool due to its interaction with the cold condenser coil. As a result, a set of cooling coils may be routed from the vacuum pump and through the collection tank so as to provide cooling action for the vacuum pump without the system consuming more energy. The cooling action extends the life of the vacuum pump and increases the overall efficiency of the system.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1A is a front view of a materials dryer according to a preferred embodiment of the present invention;

FIG. 1B is a side view of the materials dryer shown in FIG. 1;

FIG. 2 is a schematic diagram of the materials dryer shown in FIG. 1;

FIG. 3 is an exploded view of the elements of the drying chamber; and

FIG. 4 is a cross sectional view the drying chamber during the drying operation.

### DETAILED DESCRIPTION OF THE PREFERRED EMBODIMENT

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

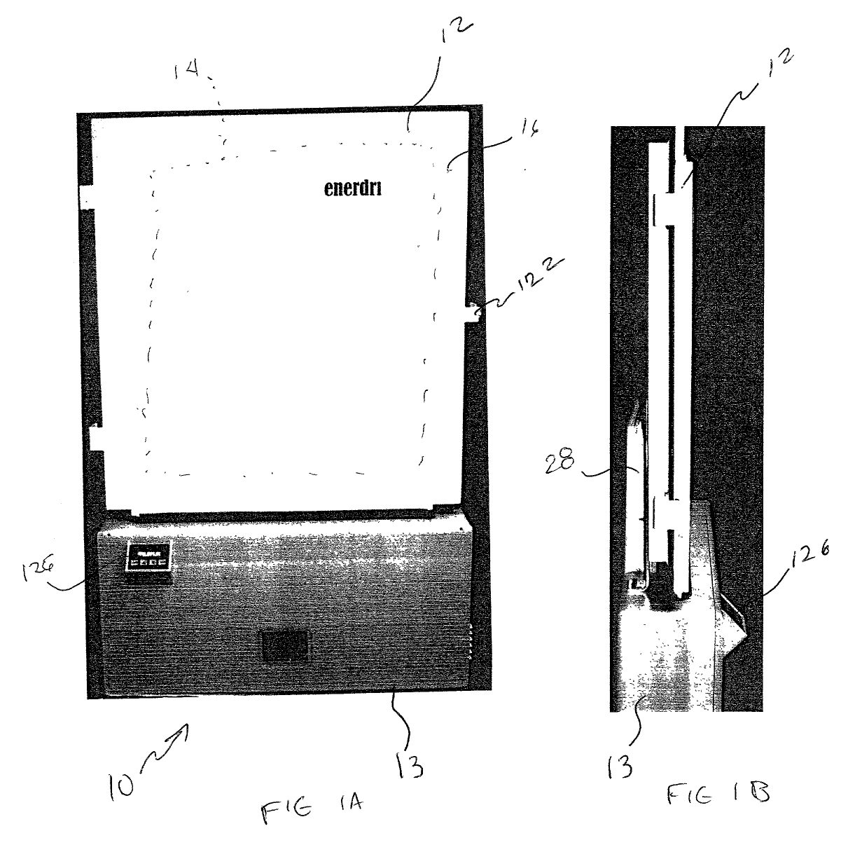

FIGS. 1A and 1B respectively illustrate front and side views of the material dryer device 10 according to the preferred embodiment of the present invention. The material dryer includes generally flat drying chamber 12 mounted in a generally upright position on a cabinet housing 13. The drying chamber 12 is hermetically sealable and has interior compartment 14 accessible through a hingedly attached door assembly 62. It will be appreciated in the illustrations in FIG. 1A and 1B, the device 10 is advantageously configured for economical use of space. The embodiment of the material device 10 is illustrated in FIGS. 1A and B is vertically oriented, however, the device 10 can also be constructed in a substantially horizontal configuration.

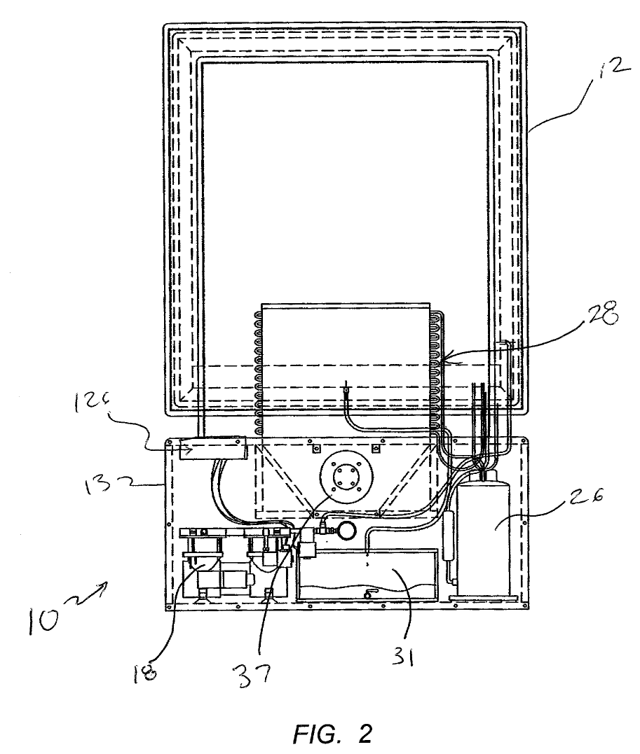

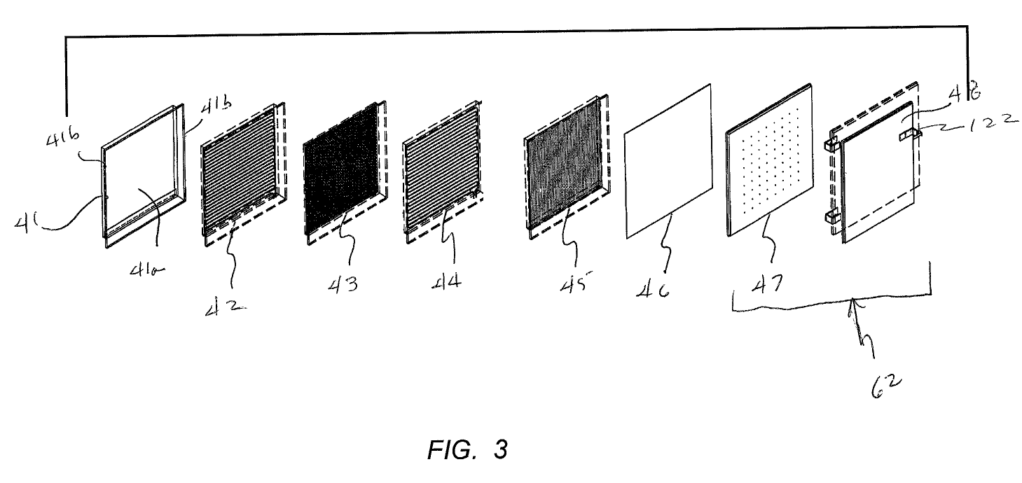

Referring to FIG. 2, set forth is a simplified schematic for the material dryer device 10 of the instant invention. The interior 14 is fluidly coupled to a vacuum pump 18 capable of a drawdown vacuum of approximately 28 inches Hg. The compressor 26 pressurizes a refrigerant, such as R134a, through compressor coil 28. A heating coil 44 (see FIG. 3) introduces heat to the material to be dried in the interior chamber 14 to produce water vapor. The cooling coil 42 (see FIG. 3) condenses the water vapor. The condensate is held until the drying cycle is complete, or if full during the cycle, purged by vacuum pump 18 through check valve to collection tank 31. The collection tank 31 may allow an overflow to drain, or include a solenoid for purging the collected water to drain. The collection tank 31 provides a ready source of fluid for creation of a water seal for operation of vacuum pump 18. A set of cooling coils 36 may be routed from the condenser coil 28 and through the collection tank so as to provide cooling action for the vacuum pump 18 without the system consuming more energy. The condensate in the collection tank is relatively cool due to its interaction with the cold condenser coil 28 and will also provide cooling action. The cooling action extends the life of the vacuum pump and increases the overall efficiency of the system. A reverse impeller fan 37 conducts waste heat from the compressor 26 into the chamber for to provide an additional heat source.

The control panel 126 provides operational control of the system. Sensors 38 are available for determining the relative humidity within the chamber, pressure of drying chamber and temperature for operation of the compressor cycle and temperature control providing operation for only the time needed to complete a drying cycle. The control panel 126 communicates with a microprocessor based controller board to control the operational elements of the dryer. The control panel 126 preferably accepts the following keyboard inputs: drying parameters to modify the drying process, manual dry times, automatic drying parameters, manual component control, and the on/off control.

An exploded view of the elements of the drying chamber 12 is shown in FIG. 3. The drying chamber 12 is constructed as a “sandwich” assembly so that each element is in intimate contact. This arrangement advantageously allows reduces the effect of atmospheric pressure exerted on the drying chamber 12 when the vacuum is drawn. A rear pan 41 forms the back and sides of the chamber 12. The rear pan 41 has a back portion 41a and sides defining a rim 41b. A cooling coil 42 rests on the rear pan 41 and condenses the water vapor that evaporates from the material being dried. A plastic separator 43 rests on the cooling coil 42 which serves to separate the heating coil 44 from the coiling coil 42. The heating coil 44 heats a heating plate 45. The heating plate 45 is a perforated to allow evaporating moisture to escape. The heating plate 45 and the membrane 46 cooperate to form the base of the interior cavity 14 of the chamber 12 which receives materials to be dried. Materials to be dried are placed in the interior cavity 14 so as to be in contact with heating plate 45. A front door assembly 62 includes perforated plate 47 and cover plate 48. The membrane 46 is stretched over and attached to the perforated plate 47. When the front door 47 is closed, the membrane 46 acts as the vacuum seal by pressing against the rim 41b of rear pan 41. When a vacuum is pulled by the vacuum pump 18, the membrane 46 is forced against the material to be dried by atmospheric pressure, and the material is forced against the heating plate 45 to aid in the conduction of heat through the material.

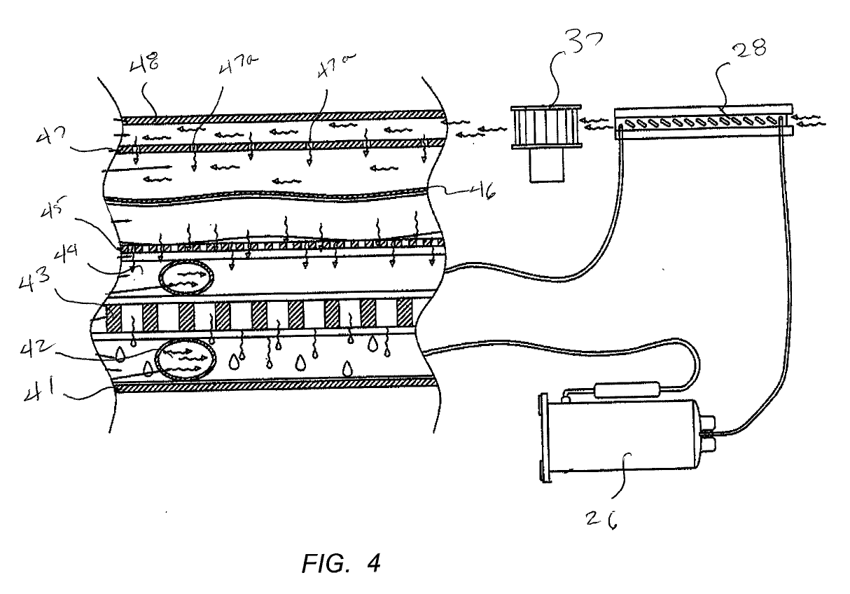

FIG. 4 illustrates a cross-sectional view of the drying chamber in operation. Wet material 51 to be dried is in the interior cavity 14. An advantage of the present invention is that the wet material can have any degree of saturation and it will not affect the performance of the dryer. In the drying process, a vacuum of approximately 28 inches Hg is drawn in the interior cavity and the heating coil 44 is heated to approximately 130-140° F. Water then evaporates from the material and the water vapor escapes through the perforations in the heating plate 46, and then passed through the perforated plastic separator 43 to reach the cooling coils 42. The cooling coils 42 condense the water vapor, and the water is discharged to the collection tank 31.

A front door assembly 62 is hingedly coupled to the rear pan 41. A solenoid operated latch opener 122 allows access to the chamber only when the vacuum is removed. The perforated plate 47 and cover plate 48 cooperate to form a plenum chamber 49. The front door assembly 62 includes a handle 76 for ease of access. When the front door assembly 62 is closed, it rest over a slot in the cabinet 11 (FIG. 1) and receives hot air drawn through the condensing coil by the by the reverse impeller fan 37. The hot air is forced through the perforations 47a to heat the membrane 46. This action advantageously recycles the waste heat from the compressor in order to introduce additional heat to the side of the material which is not in contact with the heating plate 46.

Operation of the dryer of the present invention is initiated by placing wet materials into the interior cavity and latching the front door 47 into a closed position. When the drying cycle is started, the vacuum pump 18 draws down the environment within the chamber 12 in about one minute. The compressor 26 then becomes operational in a format similar to a conventional air conditioner with the condensate coils 28 placed within the chamber 12. The compressor pressurizes freon or the like refrigerant material. The pressurized fluid is drawn through an expansion valve before placement through condensate coils 28. The condensate coils 28 draw the moisture out of the clothes wherein the condensate liquid drains into the collection tank 31. In this manner, 30 pounds of water can be evaporated in approximately 30 minutes, the system utilizing between 30,000 and 60,000 BTU's per hour. Sensors 38 may be used to monitor the time of operation or automatically determine the length of operation by determining moisture content, pressure and temperature of the chamber.

When the drying cycle commences, the vacuum pump solenoid opens, the vacuum break solenoid closes, and the vacuum pump 18 starts to evacuate the drying chamber. The refrigerant system also starts. As the vacuum increases, atmospheric pressure presses the membrane against the material to be dried. If there is a large amount of liquid in the material, much of it is pressed out without the need for evaporation. When the dryer 10 reaches its maximum operating vacuum pressure, the vacuum pump 18 turns off and the vacuum solenoid closes. When the refrigerant reaches its operating temperature, the reverse impeller fan 37 turns on to heat the membrane 46. The heat of the vaporization is supplied to the material by the heating coil 44 via the perforated heating plate 45, and the heated membrane 46. As the liquid evaporates, it passes through the perforations in the heating plate 45 and through the separator 43 to the cooling coils 42 where it condenses and gives up its heat of condensation to the refrigerant. The drying process continues with only the refrigerant compressor 26 and the impeller fan 37 operating. The microcomputer based controller monitors the temperature of the system and vacuum pressure and ends the drying cycle when its drying algorithm determines the material is dry. In a manual mode, the controller stops the drying cycle at the end of the entered time. At the end of the cycle, the refrigerant system and fan 37 are turned off, and the solenoids are opened to release the system vacuum. The liquid release solenoid is opened permitting the liquid collection tank 31 to discharge its contents to a drain. The controller preferably gives an audible sound indication that the cycle is complete. The door assembly 62 can then be opened and the material removed.

The dryer 10 of the present invention greatly reduces drying time as compared to a conventional clothing dryer, using substantially less power. The current draw of the dryer according to the preferred embodiment is 5 Amps, as compared to a 25 amp draw by a conventional dryer. In order to compare the energy usage of dryers in the drying process, a standard rating method to derive a Dryer Efficiency Rating (D.E.R) is used. This is based on the following:

1 pound of water requires approximately 1,000 BTU's to evaporate;

1 Watt-hour=3.412 BTU's

$$D . E . R . = 10 \times \frac{( \text{Wet weight lbs.} - \text{Dry Weight lbs.} ) \times 1000}{( \text{BTU/hr or} 3.412 \times \text{Watt-hrs} ) \times \text{Minutes to dry} / 60}$$

The following are examples of D.E.R. results for conventional dryers and the dryer according to the present invention:

1. A commercial gas dryer with a 250,000 BTU/hr burner can dry a 30 lb. dry weight load with a 50 lb wet weight in 15 minutes. The D.E.R. is as follows:

$$D . E . R . = 10 \times \frac{( 50 - 30 ) \times 1000}{250 , 000 \times 15 / 60} = 3.20$$

2. A residential electric dryer consumes 2,200 watts and dries a 4 lb. dry weight load with a 7 lb wet weight in 55 minutes. The D.E.R. is as follows:

$$D . E . R . = 10 \times \frac{( 7 - 4 ) \times 1000}{3.412 \times 2200 \times 55 / 60} = 4.36$$

3. A vacuum pump assisted dryer according to the present invention consumes 610 watts and dries a 0.4 lb. dry weight load with a 1 lb wet weight in 13 minutes. The D.E.R. is as follows:

$$D . E . R . = 10 \times \frac{( 10 - 0.4 ) \times 1000}{250 , 000 \times 15 / 60} = 13.30$$

It can be seen from the above examples that the dryer device of the present invention is significantly more efficient that convention dryers based on BTU's of energy expended to remove a given weight of water.

When the dried material is removed, it is in a compressed state. The materials dryer of the present the invention provides the advantage of simultaneously drying and pressing the material. In an alternative embodiment of the invention shown in FIG. 5, the heating plate 46 can have a design 139 formed in relief on the surface which serves to emboss the material being dried with the design. For example, the invention can be used emboss a raised monogram on towels or napkins. A useful application would be in establishments such as restaurants and hotels, where the name or logo could be embossed on towels and napkins. Other cloth items could be embossed using the dryer 10 to create promotional or novelty items.

There are number commercial applications where the dryer 10 of the present invention—which is compact, uses less power, and dries saturated material faster—would be highly desirable. Car washes, for example, constantly need to dry their cloth towels throughout the day. The dryer 10 is ideal for hotels, hospitals, and the like can have as substantial amount of material to be laundered on an ongoing basis. In addition to the energy efficiency of the invention, an added advantage is that the material is pressed at the same time.

The low drying temper of the dryer 10 also makes it highly desirable in certain situations. Some synthetic materials can be damaged by the high heat of a conventional dryer, and can be safely dried in a dryer according to the invention. A particularly useful application for a vacuum assisted dryer 10 of the present invention is for firefighter's clothing which cannot be subjected to high temperatures without destroying the fire-retardant properties of the material.

The dryer 10 is also particularly useful for drying bulky items, such a open-cell foam rubber and sponges, which cannot be efficiently dried by conventional dryers. Another application is for drying materials saturated with volatile liquids.

It is to be understood that while we have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What is claimed is:

1. A material dryer device comprising: a housing formed from a first shell cover hingedly secured to a second shell cover, said shell covers forming a hermetically sealed chamber defined by an interior and an exterior, said interior of said accessible upon the hingedly rotation of one said covers allowing placement of wet material inside said interior; a pump in fluid communication with said interior for drawing a vacuum in said chamber; means for elevating the temperature of said chamber; a condensate coil for condensing moisture contained in the material placed in said interior; and a container for storing condensed moisture.

2. The material dryer device according to claim 1 including a means for circulating water vapor past said condensate coils.

3. The material dryer device according to claim 1 wherein said housing is vertically orientated.

4. The material dryer device according to claim 1 including a means for pressurizing and heating fluid directed through said means to elevate chamber temperature, said pressurized and heated fluid drawn through an expansion valve juxtapositioned to said condensate coil.

5. The material dryer device according to claim 1 including a hot water preheating tank.

6. The material dryer device according to claim 5 wherein said hot water preheating tank is maintained at a temperature of about 175 F.

7. The material dryer device according to claim 1 wherein said pump has a drawdown vacuum of approximately 28 inches Hg.

8. The material dryer device according to claim 1 including a means for controlling the moisture content within said chamber.

9. The material dryer device according to claim 1 including a means for separating said condensing coil from a heating coil.

10. The material dryer device according to claim 1 wherein said covers form a plenum chamber.
